(19) United States
(12) Patent Application Publication
(10) Pub. No.: US 2013/0205089 A1
(43) Pub. Date: Aug. 8, 2013

(54) Cache Device and Methods Thereof

(71) Applicant: MediaTek Singapore Pte. Ltd., Singapore (SG)

(72) Inventors: Joern Soerensen, Aars (DK); Michael Frank, Sunnyvale, CA (US); Arkadi Avrukin, Pleasanton, CA (US)

(73) Assignee: MEDIATEK SINGAPORE PTE. LTD., Singapore (SG)

(21) Appl. No.: 13/685,728

(22) Filed: Nov. 27, 2012

Related U.S. Application Data
(60) Provisional application No. 61/596,346, filed on Feb. 8, 2012.

(51) Int. Cl. G06F 12/08

(52) U.S. Cl. CPC G06F 12/0811
USPC 711/122

(57) ABSTRACT

A cache device, coupled to a processing device, a plurality of system components and an external memory control module, capable of exchanging all types of traffic streams from the processing device and the plurality of system components to the external memory control module. The cache device includes a plurality of cache units, comprising a plurality of cache lines and corresponding to a plurality of cache sets; a data accessing unit, coupled to the processing device, the plurality of system components, the plurality of cache units and the external memory control module, capable of exchanging data of the processing device, the plurality of cache units and an external memory device coupled to the external memory control module according to at least one request signal from the processing device and the plurality of system components.

### CROSS REFERENCE TO RELATED APPLICATIONS

This application claims the benefit of U.S. Provisional Application No. 61/596346, filed on 2012 Feb. 8 and entitled “System Level Cache”, the contents of which are incorporated herein in their entirety.

### BACKGROUND

The present invention relates to a cache device and methods thereof, and more particularly, to a cache device and methods thereof capable of exchanging all types of traffic streams between a processing device and other components in a system containing the processing device.

Cache has been used for decades to improve performance of a processor. Cache is also a known technology to improve performance of a system on chip (SoC). Generally, the cache can be classified into various types, such as level 1 cache, level 2 cache and level 3 cache according to memory size and distance away from the processor.

Please refer to FIG. 1, which is a schematic diagram of a conventional cache device 102 utilized in a SoC system 10. As shown in FIG. 1, the SoC system 10 includes a processing device 100, the cache device 102, an external memory controller 104, an external memory device 106 and a plurality of system components 108. The processing device 100 is utilized for processing data acquired from the cache device 102 and the external memory device 106. The external memory device 106 can be the memory device external to the processing device 100. The plurality of system components 108 are components requiring data from the external memory device 106, such as the multimedia-function-related components, peripheral I/O, modem, etc. Please note that, traffic streams between the processing device 100 and the external memory device 106 may be directly routed through the external memory controller 104 rather than routed through the cache device 102 when the traffic streams are marked as non-cacheable. In other words, the traffic streams are directly exchanged between the processing device 100 and the external memory device 106 as long as the traffic streams are indicated not to be cached. Besides, traffic streams between the plurality of system components 108 and the external memory device 106 are not routed through the cache device 102.

Generally, the cache device 102 can be realized by static random access memory (SRAM) and is much faster and more expensive than the external memory device 106 which can be realized by dynamic random access memory (DRAM). Besides, since the operation speed of the processing device 100, e.g. a central processing unit (CPU), is much faster than the co-operations of the external memory controller 104 and the external memory device 106, the operations of the processing device 100 may be postponed certain numbers of clock cycles when accessing data from the external memory device 106. Thus, in order to increase the operation speed of the processing device 100, the processing device 100 firstly acquires data from the cache device 102 and then acquires data from the external memory device 106 when the required data cannot be found in the cache device 102.

If the probability of acquiring data from the cache device 102 increases, the idle time that the processing device 100 wastes on accessing data stored in the external memory device 106 can be reduced and the operation speed of the processing device 100 can be increased. However, the memory size of the cache device 102 is limited. Thus, how to effectively pre-fetch data from the external memory device 106 and how to timely evict data stored in the cache device 102 become important issues in the industry.

For example, if all of cache lines in a cache device have been allocated and a new data element is required to be stored, then it is necessary to evict a cache line for storing the new data element. One example of traditional replacement policy is least recently used (LRU) policy which is used to select a cache line to be evicted. The LRU policy selects a cache line that has been sitting in the cache device for the longest time without being accessed. However, some cache lines may store data which was read once and then becomes obsolete (e.g. display data). In such a condition, the LRU policy is not the optimal replacement algorithm since the cache lines storing the said data can be evicted as soon as a read operation has happened. Another example of the traditional replacement algorithm is a random replacement policy, which is often used when the LRU policy becomes prohibitively expensive to implement for cache devices with high set associativity. The random replacement policy selects a random cache line for replacement. It has been shown that the random replacement policy performs marginally worse than the LRU policy. Therefore, there is a need for selecting a cache line to be evicted in a more efficient way.

In addition, there are various methods that can be utilized for improving the performance of cache device. For example, a conventional method of reducing power consumption is to reduce number of sets of the cache device when the cache device is in low activity. However, reducing number of sets has to be in power of two because the address aliasing has to work out easily in hardware and dividing the number of sets by two is much simpler than dividing them by three or other odd numbers. However, reducing number of sets needs to change the address aliasing, which means data stored in the cache device has to be either moved around or flush-invalidated during resizing operations. For example, if reducing the size via reducing number of sets of the cache device by a factor of two, data stored in an upper half of the cache device has to be flushed and invalidated and a lower half of the cache device is available after an extra bit is stored for the tags in the lower half. On the other hand, while increasing the size of the cache device back to the original size, some data stored in the lower half may suddenly belong to the upper half (due to the address aliasing) and has to be either flush-invalidated or moved to the upper half. In such a condition, the SoC operation must be suspended during the resizing operations in both cases, to make a safe transition in size, or complicated hardware needs to be implemented to ensure data coherency.

Pre-fetching is also a known method to lower the latencies and thereby improves performance of cache device 102. A main problem of pre-fetching is that a pre-fetcher of the cache device 102 tries to predict what data will be needed next. In some cases, the prediction makes mistakes and starts loading data that will not be needed. In brief, the problems of pre-fetching include that data is being mistakenly evicted from the cache device and the extra read operations from the external memory device 106 may delay the read operations of critical data.

On the other hand, when a cache line is being replaced by a new data element required by the processing device 100, the old data stored in the cache line needs to be evicted. The cache line may be a dirty cache line (i.e. the data stored in the cache line is not consistent with the external memory device 106), thus the cache device 102 needs to write the data stored in the cache line back to the external memory device 106. However, a replacement operation of the cache line often triggers a read operation which will conflict with the write back operation of the dirty cache line. As a result, the processing device 100 maybe stalled waiting for the result of the read operation.

As can be seen from the above, in addition to effectively pre-fetching data from the external memory device and timely evicting data stored in the cache device, the methods for improving the performance of cache device are needed.

### SUMMARY

Therefore, the present invention provides a cache device and methods thereof capable of effectively pre-fetching data and clean dirty cache lines.

The present invention discloses an apparatus. The apparatus includes a cache device, coupled to a processing device, a plurality of system components and an external memory control module, capable of exchanging all types of traffic streams from the processing device and the plurality of system components to the external memory control module, the cache device including a plurality of cache units, comprising a plurality of cache lines and corresponding to a plurality of cache sets; a data accessing unit, coupled to the processing device, the plurality of system components, the plurality of cache units and the external memory control module, capable of exchanging data of the processing device, the plurality of cache units and an external memory device coupled to the external memory control module according to at least one request signal from the processing device and the plurality of system components.

The present invention further discloses a harvesting method for a cache device. The harvesting method includes counting the number of dirty cache lines of the cache device corresponding to one or more pages of an external memory device; and writing data stored in one or more dirty cache lines corresponding to a first page of the external memory device back to the external memory device when the number of the dirty cache lines corresponding to the first page exceeds a threshold and an external memory control module writes data to the first page of the external memory device; wherein the data stored in the dirty cache line is not consistent with the corresponding data stored in the external memory device.

The present invention further discloses another harvesting method for a cache device having a plurality of cache sets. The harvesting method includes counting the number of dirty cache lines in one or more cache sets; and writing the data stored in one or more dirty cache lines of a first cache set back to an external memory device when number of dirty cache lines stored in the first cache set exceeds a threshold and the external memory device performs write operations; wherein the data stored in the dirty cache line is not consistent with the corresponding data stored in the external memory device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a conventional cache device utilized in a SoC system.

FIG. 2 is a schematic diagram illustrating a cache device utilized in a SoC system according to an embodiment of the present invention.

FIGS. 3A-3C are flow charts of a resizing method according to an embodiment of the present invention.

FIG. 4 is a flow chart of a selection method according to an embodiment of the present invention.

FIG. 5 is a schematic diagram of an example of classification of cache lines according to the selection method shown in FIG. 4.

FIG. 6 is a schematic diagram of realizing the DLIP method according to an embodiment of the present invention.

FIG. 7 is a flow chart of an exemplary updating method that is suitable for cache array shown in FIG. 6.

FIG. 8 is a schematic diagram of realizing the DLIS method according to an embodiment of the present invention.

FIG. 9 is a flow chart of updating the DLIS method according to an embodiment of the present invention.

FIG. 10 is a flow chart of a pre-fetching method according to an embodiment of the present invention.

FIG. 11 is a schematic diagram of an exemplary embodiment of the pre-fetching method shown in FIG. 10.

### DETAILED DESCRIPTION

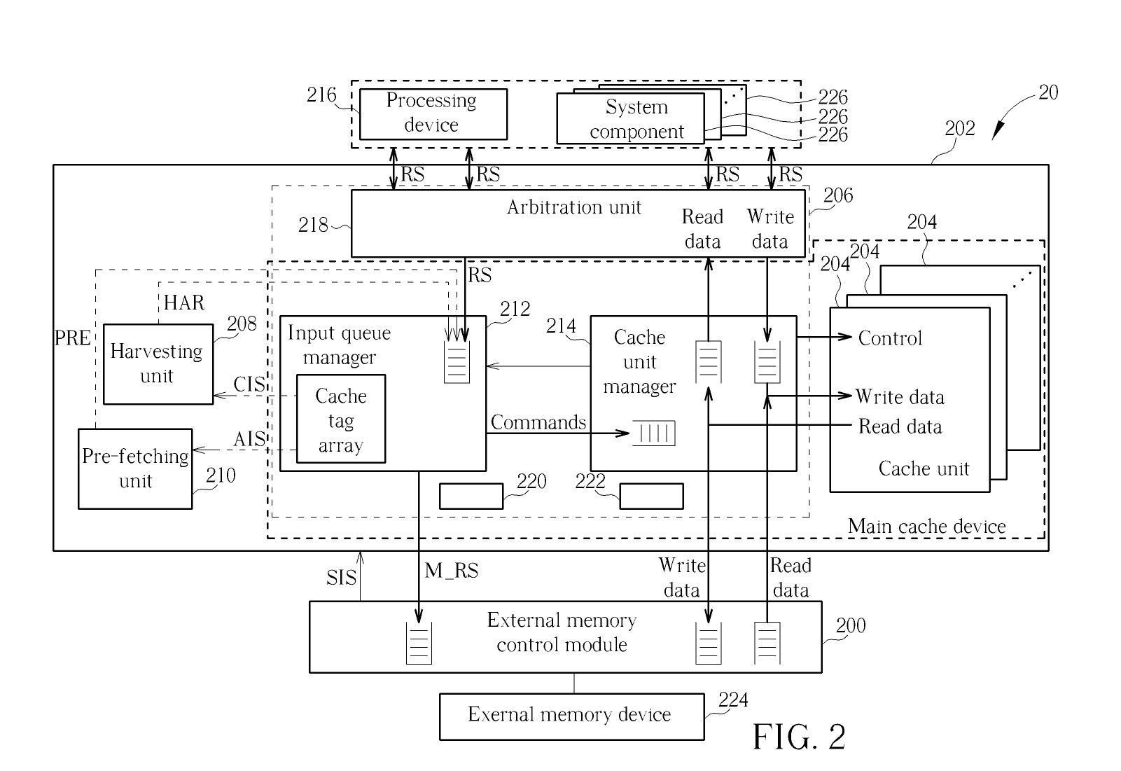

Please refer to FIG. 2, which is a schematic diagram illustrating a cache device 202 utilized in a SoC system 20 according to an embodiment of the present invention. The cache device 202 can be coupled between a processing device 216, a plurality of system components 226 and an external memory control module 200. The cache device 202 is capable of exchanging all types of traffic streams from the processing device 216 and the plurality of system components 226 to the external memory control module 200. The external memory control module 200 is capable of controlling an external memory device 224. Noticeably, the cache device 202 of the present invention can be a system level cache which is not only suitable for the processing device 216 (e.g. CPU), but also can be suitable for the plurality of system components 226 requiring data from the external memory device 224, such as multimedia-function-related components, peripheral I/O, modem, etc. The processing device 216 may be any processor, such as a central processing unit (CPU), and the external memory device 224 maybe any memory device, such as a dynamic random access memory (DRAM). As shown in FIG. 2, the external memory control module 200 can be coupled to the cache device 202 and the external memory device 224, and is capable of controlling the external memory device 224 according to a memory request signal M_RS and generating a schedule information signal SIS according to operating status of the external memory device 224. The cache device 202 is capable of exchanging data with the processing device 216 according to a plurality of request signals RS from a plurality of processing modules of the processing device 216. In an embodiment, the plurality of processing modules may be a plurality of cores of the processing device 216. Please note that, all the traffic streams between the processing device 216 and the external memory device 224 are routed through the cache device 202 including non-cacheable traffic streams.

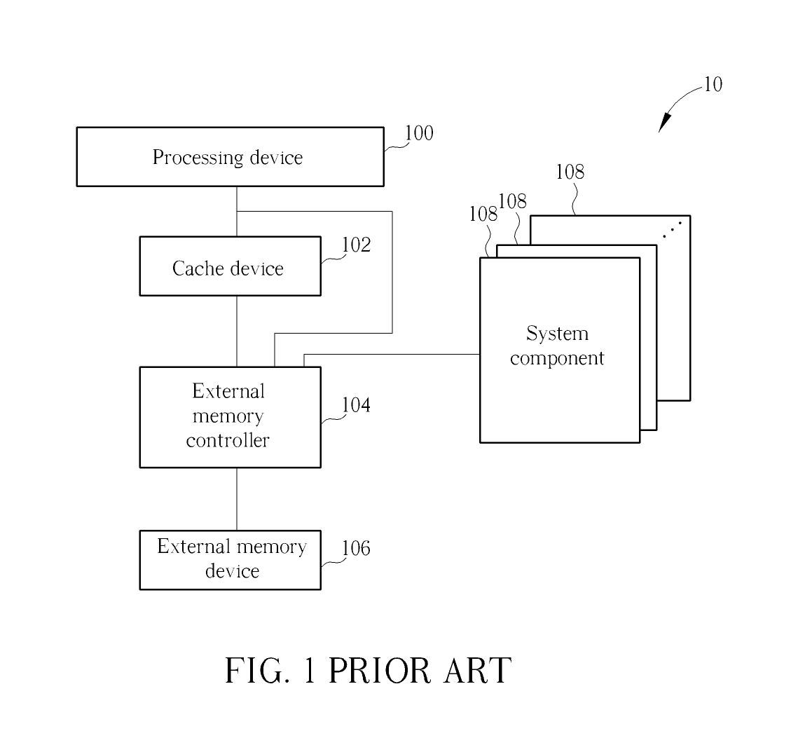

Another difference between the conventional cache device 102 shown in FIG. 1 and the cache device 202 shown in FIG. 2 is that the external memory control module 200 (corresponding to the external memory controller 104 shown in FIG. 1) can be integrated in the cache device 202 for further sharing information about the operating status of the external memory device 224, such as whether the external memory device 224 is being written or read and the current page of the external memory device 224 that is being accessed, with the cache device 202 by the schedule information signal SIS. The schedule information signal may also contain information of which pages are open in the external memory device as well as information about when the pages were opened and when they were last accessed. According to the schedule information signal SIS, the cache device 202 can select data to be harvested more accurately. The write schedule of the cache device 202 is also improved, and hence better writing efficiency can be achieved. Furthermore, the cache device 202 may use several innovative methods for improving the performance of the cache device 202 and allowing cache device 202 to operate more effectively.

Specifically, the cache device 202 may include a plurality of cache units 204, a data accessing unit 206, a harvesting unit 208 and a pre-fetching unit 210. The plurality of cache units 204 may be implemented by, for example, separate SRAM units corresponding to one or more ways of a plurality of cache sets that can be powered independently. The data accessing unit 206 may include an input queue manager 212, a cache unit manager 214, an arbitration unit 218, an importance unit 220 and a selecting unit 222. The data accessing unit 206 can be coupled to the processing device 216, the plurality of cache units 204, the harvesting unit 208, the pre-fetching unit 210 and the external memory control module 200, and is capable of controlling the plurality of cache units 204 and the external memory control module 200 according to at least one request signal from the processing device 216 such as a plurality of the request signals RS (i.e. traffic streams) corresponding to a plurality of processing modules of the processing device 216. Though harvesting unit 208 and the pre-fetching unit 210 are both included in this embodiment, please note that other embodiments can include only one of the harvesting unit 208 and the pre-fetching unit 210. The data accessing unit 206 is further capable of exchanging data of the processing device 216, the plurality of cache units 204 and the external memory device 224 according to the at least one request signal such as the plurality of request signals RS, a harvesting signal HAR and a pre-fetch signal PRE, and generating a cache information signal CIS corresponding to a plurality of cache lines of the plurality of cache units 204 and generating access information signal AIS according to plurality of the at least one request signal RS. Besides, the data accessing unit 206 can keep updating importance information of each cache line of the plurality of cache sets. The data accessing unit 206 can use the importance information to select a cache line for replacement when a new data element needs to be allocated in the plurality of cache units 204.

The harvesting unit 208 can be coupled to the data accessing unit 206, and is capable of generating the harvesting signal HAR according to the cache information signal CIS and the schedule information signal SIS to indicate the cache lines selected to be cleaned by the harvesting signal HAR. Please note that, the selected cache line is cleaned can mean that the data stored in the selected cache line is written to a storage unit of next level (e.g. a next level cache or the external memory device 224). The pre-fetching unit 210 can be coupled to the data accessing unit 206 and is capable of generating the pre-fetching signal PRE according to the access information signal AIS to control the pre-fetching operations of the data accessing unit 206.

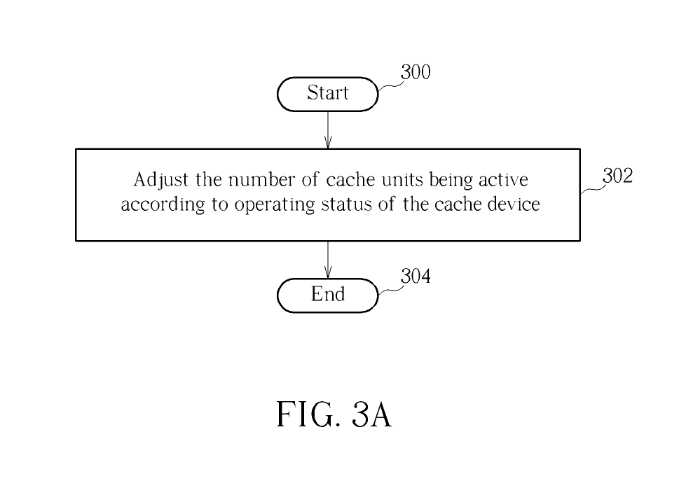

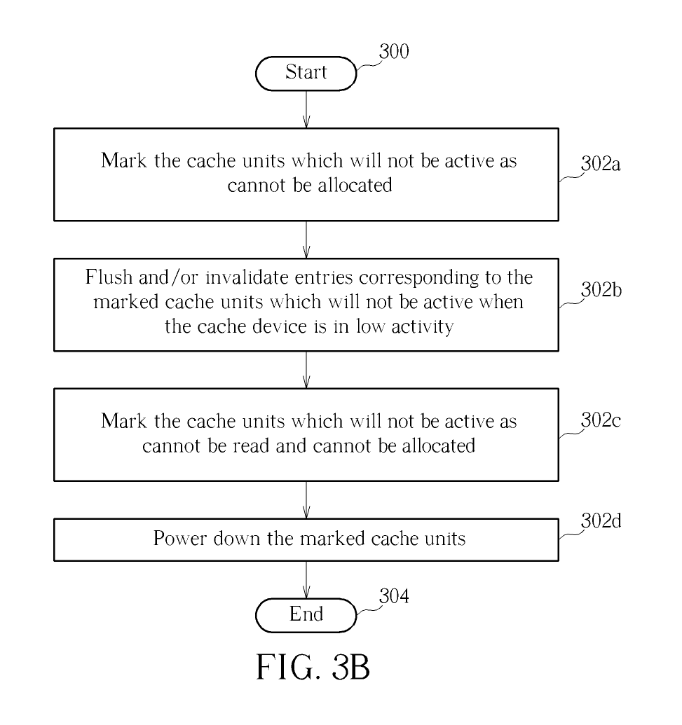

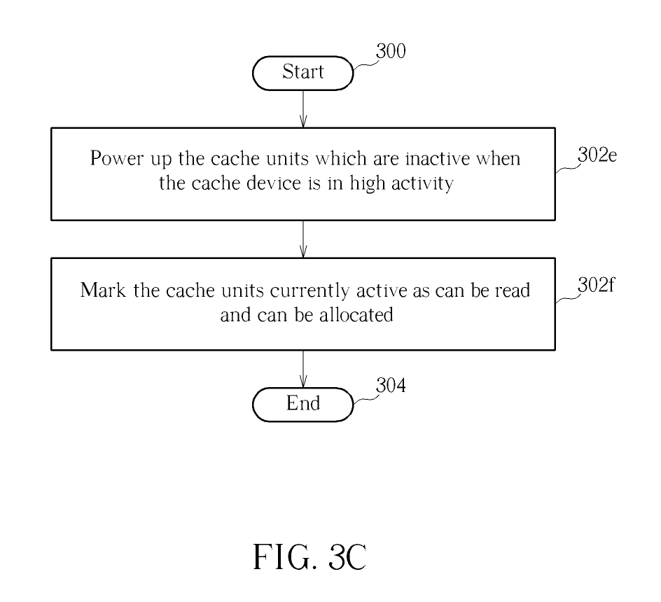

As to the detailed operations of the cache device 202, please refer to FIG. 3A which is a flow chart of a resizing method according to an embodiment of the present invention. As shown in FIG. 3A, the resizing method may include:

Step 300: Start.

Step 302: Adjust the number of cache units 204, being active according to operating status of the cache device 202.

Step 304: End.

According to the resizing method, the cache device 202 is capable of adjusting the number of cache units 204 being active (i.e. adjust the number of ways for part of or all of the cache device 202 for resizing the cache device 202) according to operating status of the cache device 202 for reducing power consumption of the cache device. For example, when the cache device is in low activity, the number of cache units 204 being active can be decreased. Please refer to FIG. 3B, which is a flow chart of realizing the resizing method when the cache device is in low activity. Noticeably, the resizing method is not limited to the sequence shown in FIG. 3B if a same result can be obtained. Also, the steps of resizing method can be increased or omitted according to different applications and are not limited herein. The resizing method shown in FIG. 3B includes:

Step 300: Start.

Step 302a: Mark the cache units which will not be active as cannot be allocated.

Step 302b: Flush and/or invalidate entries corresponding to the marked cache units which will not be active when the cache device is in low activity.

Step 302c: Mark the cache units which will not be active as cannot be read and cannot be allocated.

Step 302d: Power down the marked cache units.

Step 304: End.

According to the resizing method shown in FIG. 3B, the cache device 202, may decrease the number of the cache units 204, (e.g. decrease the number of ways of a cache array) when the cache device 202 is in low activity. First, the cache units, which will not be active, shall be marked such that no new allocations can be made in said cache units (step 302a). Second, data stored in the cache units, which will not be active, must be flushed and/or invalidated (step 302b). Third, the cache units which will not be active shall be marked, such that the read operation and the allocation are no longer allowed from the marked cache units (Step 302c). Fourth, the marked cache units can be powered down to reduce the power consumption (step 302d).

On the other hand, the cache device 202 may increase the number of cache units 204, when the cache device 202 operates in high activity. Please refer to FIG. 3C, which is a flow chart of realizing the resizing method when cache device is in high activity. Noticeably, the resizing method is not limited to the sequence shown in FIG. 3C if a same result can be obtained. Also, the steps of resizing method can be increased or omitted according to different applications and are not limited herein. The resizing method shown in FIG. 3C includes:

Step 300: Start.

Step 302e: Power up the cache units which are inactive when the cache device is in high activity.

Step 302f : Mark the cache units currently active as can be read and can be allocated.

Step 304: End.

According to the resizing methods shown in FIG. 3B and FIG. 3C, the cache device 202 can adjust the number of the cache units 204 according to activity status of the cache device 202. Please note that, ways of the cache device 102 shown in FIG. 1 are implemented by one single SRAM unit, thus the ways are fixed when the total size of the cache device 102 is determined. Different from the prior art, the present invention can use separate SRAM units, which may be mapped to one or more ways of a plurality of cache sets, thus the cache device 202 can be resized via adjusting number of cache unit 204 (e.g. adjusting the number of ways for part of or all of the cache sets). Since the SRAM units can be independently powered, one or more SRAM units can be powered up (then size of cache device 202 can be increased) or powered down (then size of cache device can be decreased) at a time. As a result, the cache device 202 can be fully operational during executing resizing method. Furthermore, the supply voltage of each SRAM unit can be independently adjusted, to further reduce power consumption. The total size of the cache array can be increased or decreased in power of two to implement the SRAM units in convenient way. However, the number of cache units is not limited to be reduced or increased in power of two.

### Replacement Policy

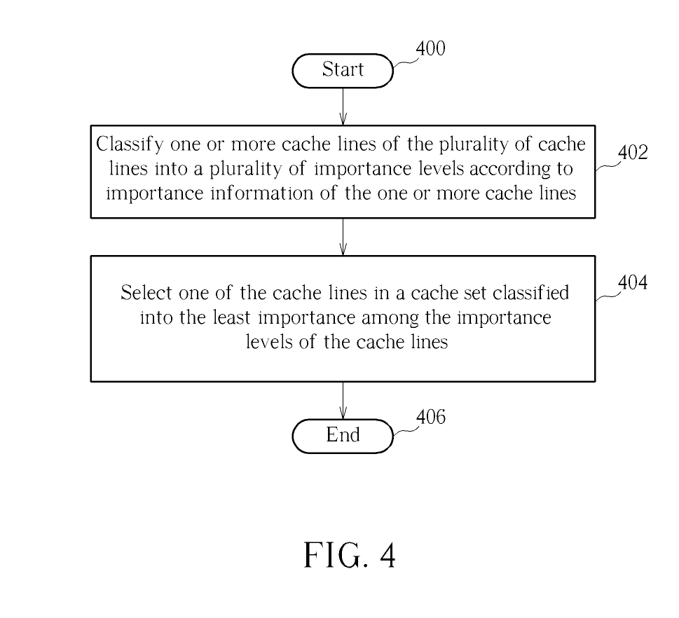

In order to improve the efficiency of selecting cache lines to be replaced, the data accessing unit 206 of the cache device 202 can adopt a selection method. Please refer to FIG. 4, which is a flow chart of the selection method according to an embodiment of the present invention. The selection method is an implementation method of the replacement policy of the cache device 202. Noticeably, the selection method is not limited to the sequence shown in FIG. 4 if a same result can be obtained. Also, the steps of the selection method can be increased or omitted according to different applications and are not limited herein. As shown in FIG. 4, the selection method can include:

Step 400: Start.

Step 402: Classify one or more cache lines of the plurality of cache lines of the plurality of cache sets into a plurality of importance levels according to importance information of the one or more cache lines.

Step 404: Select one of the cache lines classified into the least importance among the importance levels of cache lines in a cache set.

Step 406: End.

According to the selection method, the selecting unit 222 of the data accessing unit 206 is capable of using importance information of one or more cache lines (e.g. the previous experience about lifetime of data currently stored in the one or more cache lines) of the plurality of cache sets for further classifying the one or more cache lines into a plurality of importance levels. The importance information of the one or more cache lines can be provided by the importance unit 220 of the data accessing unit 206. The importance unit 220 is utilized for updating importance information of each cache line of the plurality of cache sets. In some embodiments, the selecting unit 222 of the data accessing unit 206 is capable of classifying each cache line into the plurality of importance levels according to the importance information. Thus, the selecting unit 222 can efficiently select the cache line to be replaced.

For example, the importance of display data maybe lower once the display data has been read. Thus, if data stored in the cache line is display data, the cache line can be labeled with lower importance level once the display data stored in the cache line has been read. In addition, since the pre-fetched data would be read in the near future, the cache line storing the pre-fetched data can be labeled with higher importance level. Once the pre-fetched data has been read, the importance level of the cache line storing the pre-fetched data that has been read can be changed to a lower importance level.

In addition, the data generated by a specific processing module of the processing device 216 can be always highly important. Thus, the cache line storing the data generated by the specific processing module can be labeled with higher importance level. On the contrary, another processing module of the processing device 216 may generate less important data. Thus, the cache line storing the data generated by the processing module can be labeled with lower importance level. The importance information of the cache lines may therefore includes the processing modules of the processing device 216 which accesses the cache lines, and then the importance levels of the cache lines are changed according to the processing modules accessing data of the cache lines. For example, the importance level of a cache line can be changed according to whether the processing modules accessing data of the cache line enables pre-fetching operation. Once the data stored in the cache line has been read by the processing module which enables the pre-fetching operations, the importance level of the cache line can be set to the lowest importance level. However, if the data of the cache line is accessed later by another processing module, the importance level of the cache line can be set to a higher importance level.

As a result, via classifying one or more cache lines into different importance levels, the selecting unit 222 can firstly select a cache line with least importance level among the cache lines in a cache set to be replaced. Thus, the replacement policy of the cache device 202 would be more efficient.

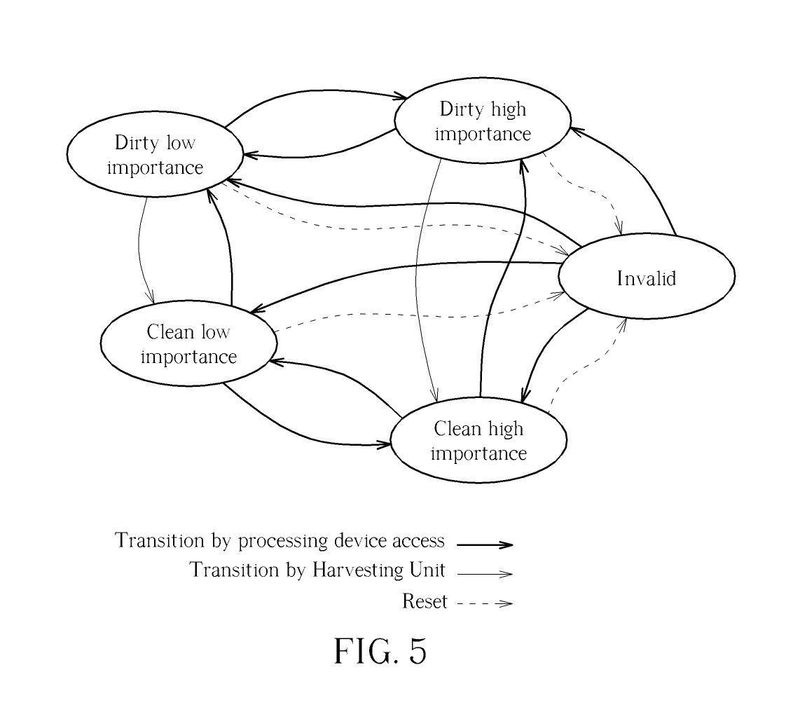

Please refer to FIG. 5, which is a schematic diagram of an example of classification of cache lines according to the classification of the selection method. As shown in FIG. 5, the cache lines can be firstly classified into invalid, clean and dirty according to data stored in the cache line. Generally, an invalid cache line can be a cache line that holds invalid data and obviously can be a candidate for replacement. A clean cache line can mean the cache line holds valid data and data stored in the cache line is consistent with the corresponding data stored in the external memory device. The dirty cache line means the cache line holds data that has not yet been written to the external memory device. Via the classification of the selection method, the cache lines can further be labeled according to the importance information of each cache line. The dirty cache lines can be divided into dirty high importance cache lines and dirty low importance cache lines according to the importance information. Similarly, the clean cache lines can be divided into clean high importance cache lines and clean low importance cache lines according to the importance information. Therefore, the priority sequence of selecting among cache lines to be replaced can be changed to:
1. Invalid cache line
2. Clean low importance cache line
3. Clean high importance cache line
4. Dirty low importance cache line
5. Dirty high importance cache line

Please note that, the importance levels are not limited to level of high importance and level of low importance, and can include more than two importance levels.

Moreover, the importance level of a cache line may be changed due to operations of the cache device 202. Please refer to FIG. 5, a dirty high importance cache line may be changed to a dirty low importance cache line after accessed by the processing device 216 or other components. The dirty low importance cache line may be changed to the dirty high importance cache line when the dirty low importance cache line is frequently accessed by the processing device 216. The transition between the clean high importance cache line and the clean low importance cache line can be similar to that between the dirty high importance cache line and the dirty low importance cache line.

Besides, when the selecting unit 222, decides to write data stored in a cache line to the external memory device 224 (e.g. selects the cache line to be cleaned), the cache line may be changed to clean low importance cache line or the invalid cache line. Please note that, it is legal to invalidate the cache line as data has been written to the external memory device 224. The cache line can therefore be retrieved if needed. On the other hand, the clean low importance cache line may indicate that the cache line is the first candidate to be replaced, but also indicates that the cache line still holds valid data.

The selecting unit 222 may decide to write data stored in a dirty high importance cache line to the external memory device 224 before data is read by processing device 216 or other components. In such a condition, the dirty high importance cache line may be changed to clean high importance cache line when the selecting unit 222 writes data stored in the dirty high importance cache line to the external memory device 224. Then, when the processing device 216 or other components read data stored in the clean high importance cache, the clean high importance cache line may be changed to clean low importance cache line or invalid cache line.

### Harvesting Unit

According to the selection method, the invalid cache line(s) and the clean cache line(s) (including the clean high importance cache line(s) and the clean low importance cache line(s)) can be preferentially to be replaced. As a result, all the cache lines of the cache device 202 may be expected to become dirty over time. If all the cache lines have become dirty cache lines (including the dirty high importance cache line(s) and the dirty low importance cache line(s)), the selecting unit 222 may be forced to select dirty cache lines to be evicted. Eviction of a dirty cache line can be an expensive task in terms of latency and bandwidth efficiency as data stored in the evicted dirty cache line must be written to the external memory device 224 and may collide with critical read traffic streams on the external memory bus. For example, the external memory device 224 can be a DDR memory device which is pipelined and has a bidirectional bus. If a write operation is performed while the external memory device 224 performs read operation, it is necessary to empty the read pipeline, and then turn the bidirectional bus around, fill and empty the write pipeline, turn the bidirectional bus around and fill the read pipeline to resume the read operation. As a result, it is not desirable to perform write operations to external memory device 224 while there is heavy read traffic. In addition, the external memory device 224 can be a DRAM which is organized into banks and pages. When the written page of a write operation does not equal to the current open pages of the external memory device 224, further delays in the external memory device is caused, such that the performance is decreased accordingly.

Thus, the harvesting unit 208 is capable of collecting the dirty cache lines according to the cache information signal CIS as candidates to be cleaned, and controlling the data accessing unit 206 to clean the candidates according to the schedule information signal SIS, so as to optimize the write schedule to the external memory device 224, such as DRAM. The harvesting unit 208 is utilized for collecting information about location of the dirty cache lines in the cache device 202 and the pages of the external memory device 224 corresponding to the dirty cache lines. The harvesting unit 208 is therefore capable of generating a list of cache lines to be the candidates for cleaning, so as to ensure each cache set of the cache device 202 has a minimum number of clean cache lines for the selection method when evicting a cache line. In such a condition, the write operations of writing the candidates back to the external memory device 224 can be performed when the external memory device 224 performs other write operations. Please note that, the performance of the cache device 202 is also improved when the write operations of writing the candidates back to the external memory device 224 is performed when the external memory device 224 has light read traffic. According to the concept above, the present invention provides three harvesting methods named dirty lines in page (DLIP) method, dirty lines in set (DLIS) method and dirty lines in cache (DLIC) method.

Specifically, the main idea of the DLIP method is that the harvesting unit 208 can collect information about dirty cache lines belonging to the same page of the external memory device 224 according to the schedule information signal SIS and the cache information signal CIS, and then can write data stored in the dirty cache lines belonging to the same page to the external memory device 224 when the number of the dirty cache lines corresponding to the same page exceeds a threshold TH1 and the external memory device 224 performs write operations to the same or another memory page.

On the other hand, the main spirit of the DLIS method is that the harvesting unit 208 can clean one, more or all the dirty cache lines stored in the same cache set, when the number of the dirty cache lines in the cache set exceeds a threshold TH2 and the external memory device 224 performs write operations. Further, when the harvesting unit 208 cleans one or more cache lines of a cache set corresponding to certain pages of the external memory device 224, the harvesting unit 208 can clean one or more cache lines of other cache sets corresponding to the same page. This is the case that the DLIS method is followed by DLIP method.

In addition, the main concept of the DLIC method is that the harvesting unit 208 can clean one, more or all the dirty cache lines in the plurality of cache sets when the number of the dirty cache lines in the plurality of cache sets exceeds a threshold TH3 and the external memory device 224 performs write operations.

The three methods (i.e. the DLIP method, the DLIS method and the DLIC method) can be utilized separately or in any combination. In one embodiment, since the DLIP method is able to collect dirty cache line belonging to current open pages of the external memory device 224, the write schedule can be optimized to generate the least overhead in the external memory device 224, the DLIP method can be preferentially performed. In another embodiment, the DLIP method, the DLIS method and the DLIC method can also be performed at the same time. For example, the harvesting unit 208 may include a DLIP counter capable of counting the total number of dirty cache lines corresponding to one or more pages of the external memory device 224, a DLIS counter capable of counting the total number of dirty cache lines corresponding to one or more cache sets, and a DLIC counter capable of counting the total number of dirty cache lines in the cache device 202.

Please note that, the dirty cache lines collected by the DLIP method, the DLIS method and the DLIC method can be cleaned when the external memory device 224 is in low traffic status. To optimize the efficiency of the write schedule to the external memory device 224, it may be necessary to write back the dirty cache line belonging to specific pages and/or banks of the external memory device 224, wherein the specific pages and/or banks of the external memory device 224 may be determined according to the schedule information signal SIS (i.e. the information about current and past operating status of the external memory device 224). Moreover, since the information of the dirty cache lines is made available through cache tag array lookups when the cache device 202 is performing accesses with its normal operation, harvesting unit 208 can keep recording the statuses of the dirty cache lines without generating any negative effect on the performance of cache device 202.

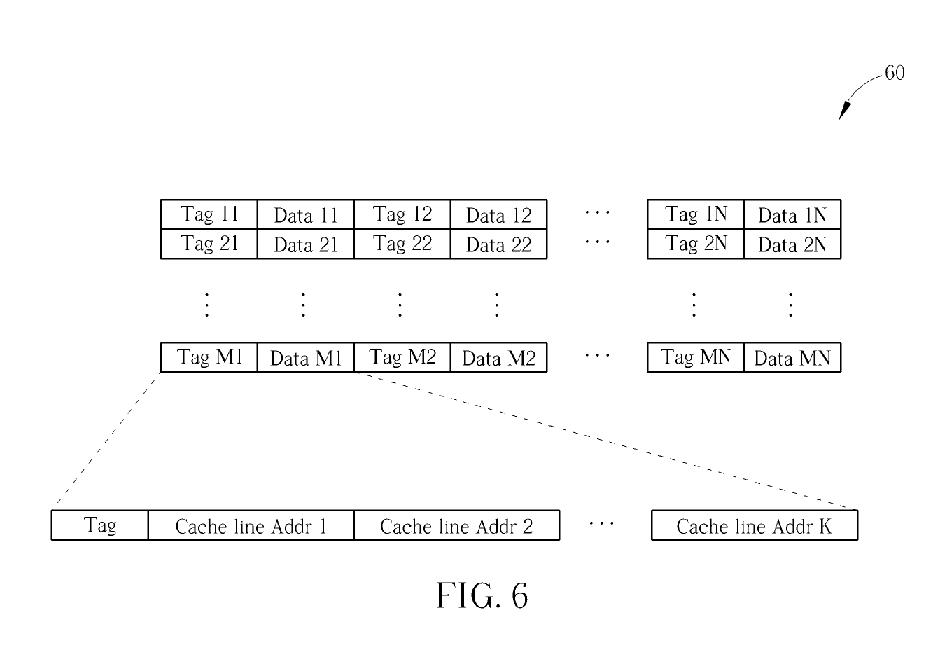

According to different system requirements, the DLIP method, DLIS method and the DLIC method may be realized in various ways. Please refer to FIG. 6, which is a schematic diagram of realizing the DLIP method according to an embodiment of the present invention. As shown in FIG. 6, a cache array 60 is suitable for an N-Way cache device, with the capability of storing K dirty line indexes. A first part of the address corresponding to the pages P1-Pi can be used as entry tags and a second part of the address can be used as the entry indexes. Each tag of tags Tag 11-Tag 1N, Tag 21-Tag 2N, . . . , Tag M1-Tag MN can store the first part of the address corresponding to one of the pages P1-Pi of the external memory device. The data Data 11-Data 1N, Data 21-Data 2N, . . . , Data M1-Data MN corresponds to the tags Tag 11-Tag 1N, Tag 21-Tag 2N, . . . , Tag M1-Tag MN, respectively. The data Data 11 can store at least necessary information about the locations of the dirty cache lines corresponding to the memory page indicated by the tag and index of Tag 11. The at least necessary information stored in the data Data 11 may be part of the address of the dirty cache line which is not contained in the second part of the memory page address and the way number of the dirty cache line in the main cache device. The data Data 12 can store at least necessary information about the locations of the dirty cache lines corresponding to the memory page indicated by the tag Tag 12, and so on. As a result, the cache array 60 can keep track of the number of dirty cache lines corresponding to one or more pages of the external memory device 224. The locations of the dirty cache lines in the main cache device belonging to a specific page of the external memory device 224 can be easily found by looking up the cache array 60.

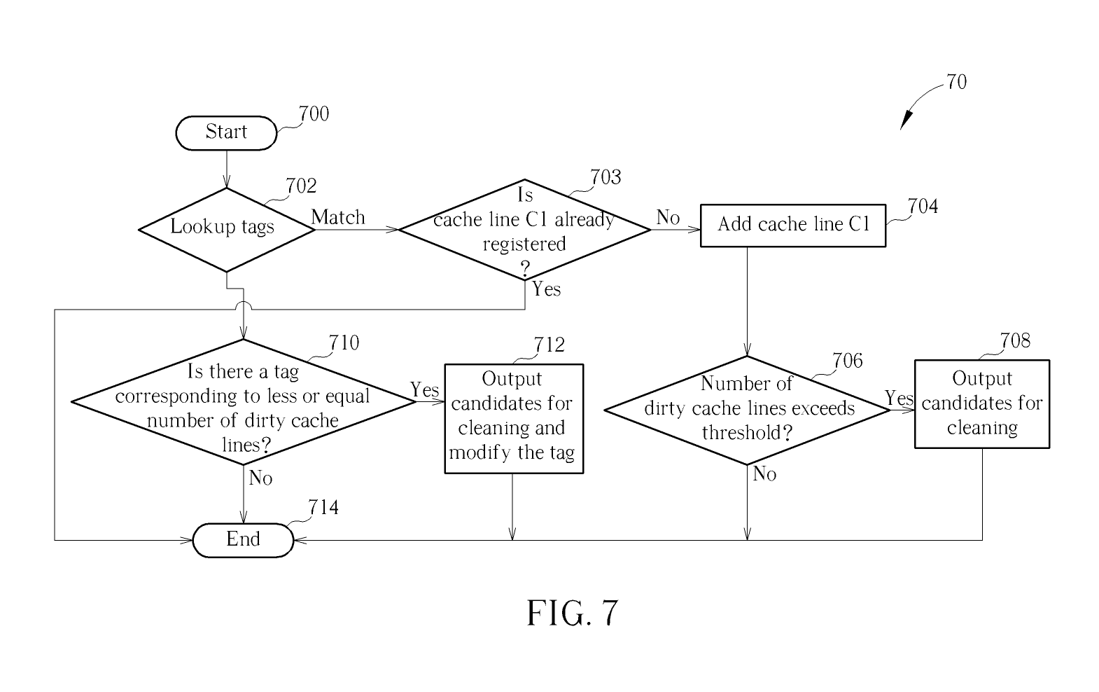

As to the update of the cache array 60, please refer to FIG. 7 which is a flow chart of an exemplary updating method 70 suitable for the cache array 60 shown in FIG. 6. Noticeably, the updating method 70 is not limited to the sequence shown in FIG. 7 if a same result can be obtained. Also, the steps of updating method 70 can be increased or omitted according to different applications and are not limited herein. The updating method 70 can be executed when a cache line C1 is changed to dirty cache line and can include:

Step 700: Start.

Step 702: Look up whether the pages corresponding to tags Tag 11-Tag 1N, Tag 21-Tag 2N, . . . , Tag M1-Tag MN include the page corresponding to the dirty cache line C1. If the page corresponding to a tag T1 matches the page corresponding to the cache line C1, execute Step 703; otherwise, execute Step 710.

Step 703: Check if the dirty cache line C1 is already registered in the data corresponding to the tag T1. If it is already registered, execute step 714; otherwise, execute step 704.

Step 704: Add the address of the cache line C1 to the data corresponding to the tag T1.

Step 706: Determine whether the number of dirty cache lines corresponding to the tag T1 exceeds the threshold TH1. If the number of dirty cache lines corresponding to the tag T1 exceeds the threshold TH1, execute step 708.

Step 708: Output the data corresponding to the tag T1 as candidates for cleaning and invalidating the entry in cache array 60.

Step 710: Determine whether there is a tag corresponding to a page storing less or equal number of dirty cache lines than the page corresponding to the cache line C1. If there is a tag T2 storing less or equal number of dirty cache lines, execute step 712.

Wherein, the tag may correspond to part of the page. For example, the tag may correspond to one or more bits of the address of the page.

Step 712: Output the data corresponding to the tag T2 as candidates for cleaning and modify the tag T2 and the corresponding data of the tag T2 to associate with the page corresponding to cache line C1.

Step 714: End.

According to the updating method 70, the cache array built for the DLIP method can be updated. Please note that, the updating method 70 can be performed whenever a dirty cache line is being accessed.

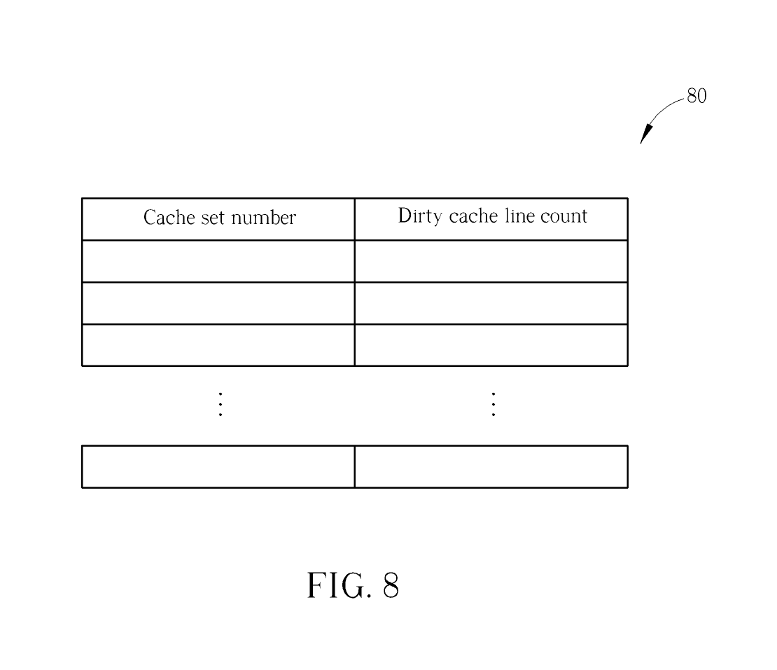

Please refer to FIG. 8, which is a schematic diagram of realizing the DLIS method according to an embodiment of the present invention. As shown in FIG. 8, the DLIS method may be realized by building a table 80 in a buffer (not shown). The table 80 may include a cache set number column and a dirty cache line count column. The cache set number column can be utilized for storing the cache index corresponding to a cache set in the main cache device. The dirty cache line count column can be utilized for storing the number of dirty cache line stored in the cache set corresponding to the cache index of the same row. The top-down sequence of the cache set number column can be determined according to the number of dirty cache lines stored in a cache set corresponding to each cache index number stored in the cache set number column. Via keep updating the table 80 during operating, the harvesting unit 208 can output candidates for cleaning when the dirty cache line count corresponding to a cache unit 204 (i.e. the number of dirty cache lines stored in the cache set) exceeds the threshold TH2. Please note that, when outputting candidates for cleaning, the harvesting unit 208 may further look up the cache array 60 built by the DLIP method for cleaning some or all of the dirty cache lines corresponding to the same pages of the external memory device 224.

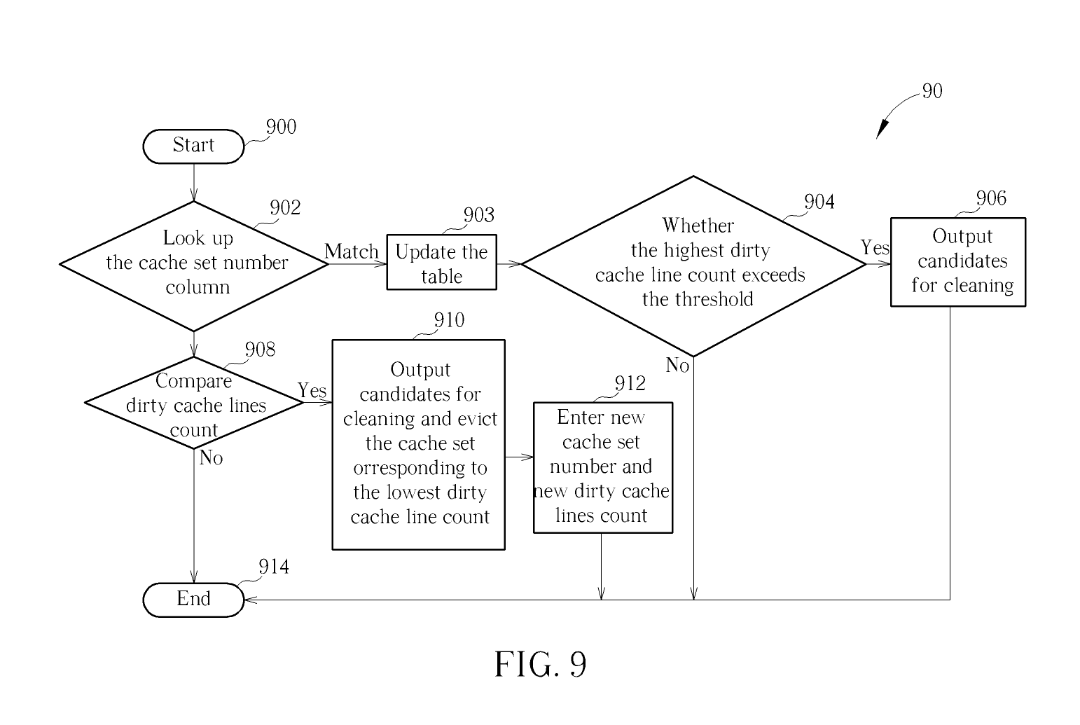

Please refer to FIG. 9, which is a flow chart of updating the DLIS method according to an embodiment of the present invention. Noticeably, the updating method 90 is not limited to the sequence shown in FIG. 9 if a same result can be obtained. Also, the steps of updating method 90 can be increased or omitted according to different applications and are not limited herein. The updating method 90 can be executed when a cache line C2 is changed to dirty cache line and can include:

Step 900: Start.

Step 902: Look up whether the cache set number column of the table 80 includes the cache set number corresponding to the cache line C2. If the cache set number column of the table 80 includes the cache unit number corresponding to the cache line C2, execute step 903; otherwise, execute step 908.

Step 903: Update the dirty cache line count corresponding to the cache set number found matched in step 902.

Step 904: Determine whether the highest dirty cache line count in the table 80 exceeds the threshold TH2. If the highest dirty line count of the table 80 exceeds the threshold TH2, execute step 906; otherwise, proceed to step 914

Step 906: Output the dirty cache lines of the cache set corresponding to the highest dirty cache line count as candidates for cleaning. Then proceed to step 914.

Step 908: Compare the dirty cache line count corresponding to the cache set of the cache line C2 with the lowest dirty cache line count in the table 80. If the dirty cache line count corresponding to the cache set of the cache line C2 is greater than the lowest dirty cache line count in the table 80, execute step 910; otherwise, proceed to step 914.

Step 910: Output the dirty cache lines of the cache set corresponding to the lowest dirty cache line count as candidates for cleaning and evict the cache set corresponding to the lowest dirty cache line count. Then proceed to step 912.

Step 912: Enter the cache set number and the dirty cache lines count corresponding to the cache line C2 into the table 80. Then proceed to step 914.

Step 914: End.

According to the updating method 90, the table 80 built for the DLIS method can be updated.

The DLIC method can be realized by a DLIC counter capable of counting the total number of dirty cache lines in the cache device 202. The beauty of the DLIC counter is that the DLIC counter is not maintained by expensive operations (e.g. walking the plurality of cache units), but is maintained by detecting whether a status of a cache line changes (e.g. changes from dirty to clean or from clean to dirty).

### Pre-Fetching Unit

Moreover, the pre-fetching unit 210 of the cache device 202 is capable of determining whether to pre-fetch data for a processing module of the processing device 216 according to the access information signal AIS. The access information signal AIS is capable of indicating a priori information of behaviors of the processing module. According to the access information signal AIS, the pre-fetching unit 210 is capable of controlling the data accessing unit 206 to pre-fetch data for the processing module according to whether the access pattern of the processing module is systematic. For example, the access information signal AIS may indicate the size and/or the stride of at least one access by the processing module. The at least one access may be of a plurality of contiguous accesses. In one embodiment, the pre-fetching unit 210 may determine whether to pre-fetch data for the processing module according to the size and/or the stride of each access by the processing module As a result, the pre-fetching unit 210 can separately control the pre-fetching operations corresponding to different processing modules of the processing device 216. Please note that, since the access information, such as access information signal AIS, is available to the cache device 202, the pre-fetching unit 210 can operate independently in parallel with the normal operations of the cache device 202. Thus, the pre-fetching unit 210 has no negative effect on the performance of cache device 202.

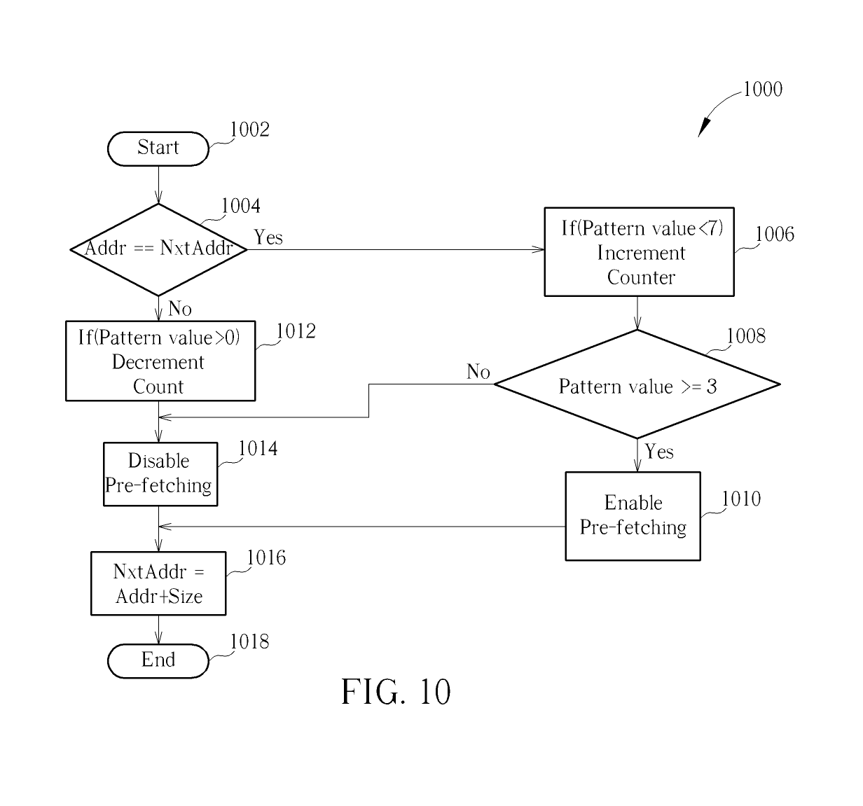

Please refer to FIG. 10, which is a schematic diagram of a pre-fetching method 1000 according to an embodiment of the present invention. Noticeably, the pre-fetching method 1000 is not limited to the sequence shown in FIG. 10 if a same result can be obtained. Also, the steps of pre-fetching method 1000 can be increased or omitted according to different applications and are not limited herein. The pre-fetching method 1000 can be utilized in the pre-fetching unit 210 and can include:

Step 1002: Start.

Step 1004: Determine whether a prediction address equals a current address. The prediction address is calculated according to an address and a size of a first access by a processing module. The current address is an address of a second access by the processing module which is executed after the first access. If the prediction address equals the current address, execute step 1006; otherwise execute step 1012.

Step 1006: Increase a pattern value corresponding to the processing module when the pattern value is smaller than a first predetermined number, such as 7 or any other number according to the design requirement.

Step 1008: Determine whether the pattern value is greater than or equals a threshold, such as 3 or any other threshold according to the design requirement. If the pattern value is greater than or equals the threshold, execute step 1010; otherwise, execute step 1014.

Step 1010: Control the data accessing unit 206 to start pre-fetching data for the processing module.

Step 1012: Decrease the pattern value corresponding to the processing module when the pattern value is greater than a second predetermined number, such as 0 or any other number according to the design requirement.

Step 1014: Control the data accessing unit 206 to stop pre-fetching data for the processing module.

Step 1016: Calculating the prediction address according to the size and the address of the current access.

Step 1018: End.

According to the pre-fetching method 1000, the pre-fetching unit 210 can determine whether to pre-fetch data for the processing module. Please not that, the pattern value is within 0 to 7 in this embodiment, but is not limited herein.

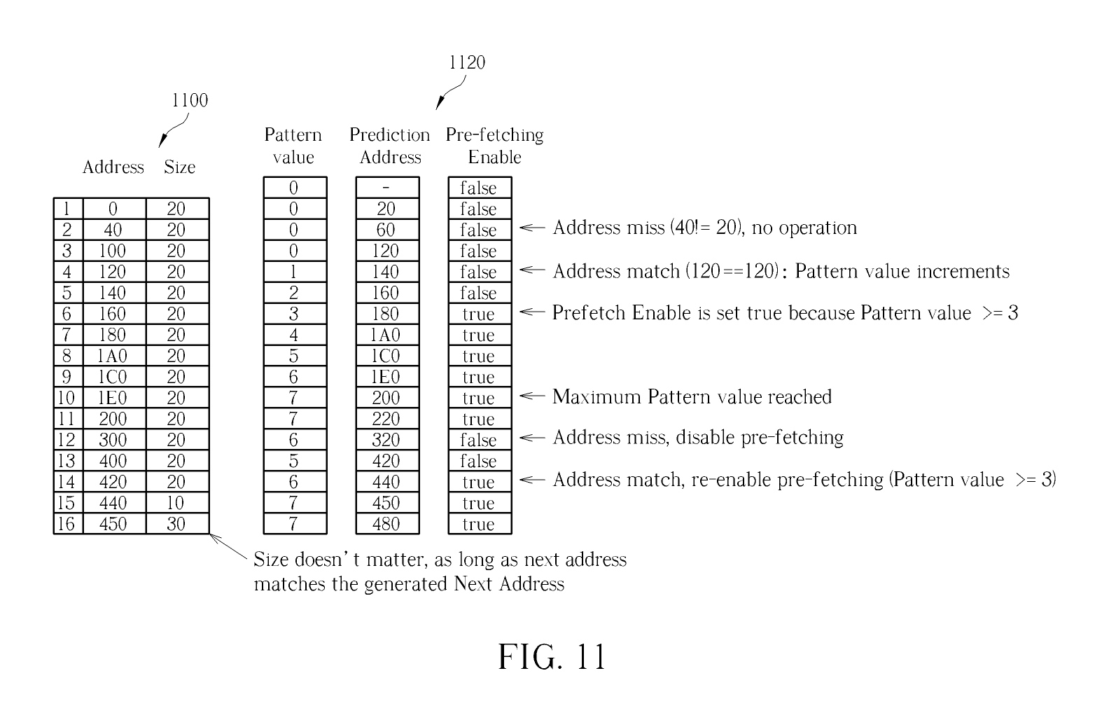

Please jointly refer to FIG. 11, which is a schematic diagram illustrating an exemplary operation of pre-fetching method 1000. As shown in FIG. 11, a table 1100 illustrates a sequence of addresses and sizes of 16 contiguous accesses by the processing module and another table 1120 illustrates the resulting pattern value, the resulting prediction address and the resulting pre-fetching enable status are determined by the pre-fetching unit 210. Please note that the access sequences in tables 1100 and 1120 are illustrative only. For example, addresses and sizes of any number of accesses by the processing module can be included in the table 1100 according to operations of a real system. For example, at the first access, the pre-fetching unit 210 is capable of calculating the prediction address as 20 according to the address and the size of the first access. At the second access, the pre-fetching unit 210 is capable of determining that the prediction address, such as 20 in this example, does not equal the address of the second access. But in this example, the pattern value is 0, thus the pattern value is maintained at 0. The status of pre-fetching enable is false. Via repeating the pre-fetching method 1000, the pre-fetching unit 210 can automatically control the pre-fetching operations according to the address and the size of one or more accesses by the processing module.

Noticeably, in this invention, all types of traffic streams between the processing device 216 and other components in the SoC system 20 containing the processing device 216 can be routed through the cache device 202, wherein the external memory control module 200 is capable of controlling the external memory device 224. Also, the external memory control module 200 can be integrated into the cache device for providing the schedule information of the external memory device 224, to enhance the operations of the cache device 202. Via improving the write schedule of the external memory device 224 by injecting the write operations of the dirty cache lines that fits beneficially into the write schedule, the write schedule can be greatly improved. Similarly, the read schedule of the external memory device 224 can be improved by injecting the read operations of the pre-fetched data into the read schedule. Beside, since the cache device 202 of the present invention can be implemented by separate SRAM units corresponding to one or more ways, the cache device 202 can be fully operational during resizing of the cache device 202. On the other hand, via classifying the cache lines into importance level according to the importance information of the cache lines, the selecting unit of the cache device can more accurately select the cache lines to be replaced. Please note that, the importance information of the cache lines can be updated according to behaviors of the processing module accessing the cache lines, such as the operations performed by the processing module (ex. read operations or write operations) and whether the processing module is allowed to pre-fetch data. Moreover, the above embodiments disclose the DLIP method, the DLIS method and the DLIC method for indicating the cache device to effectively clean the dirty cache lines. The DLIP method and the DLIS method enables the harvesting unit 208 to easily identify the locations of the dirty cache lines without performing an expensive search in the cache tag array implemented in the input queue manager 212. In addition, the pre-fetching operations of the cache device 202 can be dependent on behaviors of different processing modules, to improve the efficiency of the cache device 202.

According to different applications, those skilled in the art may accordingly observe appropriate alternations and modifications. For example, the harvesting unit 208 and pre-fetching unit 210 do not need to be realized in the cache device 202 at the same time. However, the performance of the cache device 202 maybe enhanced when the harvesting unit 208 and the pre-fetching unit 210 are both implemented in the cache device 202. Please note that, the operations of updating the data structures of DLIC method, DLIS method, DLIP method and pre-fetching unit 210 to maintain information about locations of dirty cache lines can be operated in parallel with the normal cache operation of the cache device 202 and do not require any extra information beyond the information being looked up in the cache during the normal operations. In addition, all the steps of methods mentioned above are illustrative only. According to different design requirements, the order of steps can be changed, the steps can be performed in parallel, some of the steps can be omitted and additional steps can be added.

Via various methods disclosed in the present invention, the performance of cache device in the present invention can be effectively improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An apparatus comprising:
a cache device, coupled to a processing device, a plurality of system components and an external memory control module, capable of exchanging all types of traffic streams from the processing device and the plurality of system components to the external memory control module, the cache device comprising:
a plurality of cache units, comprising a plurality of cache lines and corresponding to a plurality of cache sets;
a data accessing unit, coupled to the processing device, the plurality of system components, the plurality of cache units and the external memory control module, capable of exchanging data of the processing device the plurality of cache units and an external memory device coupled to the external memory control module according to at least one request signal from the processing device and the plurality of system components.

2. The apparatus of claim 1, wherein the external memory control module is integrated into the cache device.

3. The apparatus of claim 1, the cache device further comprising:
a harvesting unit, coupled to the data accessing unit, capable of generating a harvesting signal according to a cache information signal generated by the data accessing unit and a schedule information signal, generated by the external memory control module according to operating status of an external memory device, to the data accessing device for indicating the cache lines selected as candidates for cleaning.

4. The apparatus of claim 3, wherein the schedule information signal is capable of indicating a plurality of current open pages and when the last activate commands and the last close commands were issued in each page of the external memory device.

5. The apparatus of claim 3, wherein the harvesting unit is capable of selecting one or more dirty cache lines of a first cache set as the candidates for cleaning when the number of dirty cache lines stored in the first cache set exceeds a threshold, and the harvesting unit comprises:
a counter, capable of counting number of dirty cache lines in one or more cache sets, the data stored in the dirty cache line is not consistent with the corresponding data stored in the external memory device.

6. The apparatus of claim 5, wherein the harvesting unit is capable of selecting one or more dirty cache lines of a second cache set as the candidates for cleaning corresponding to a first page of the external memory device when selecting one or more dirty cache lines of the first cache set corresponding to the first page back to the external memory device.

7. The apparatus of claim 5, wherein the harvesting unit is capable of building a table for ranking the number of dirty cache lines in one or more cache sets and selecting one or more dirty cache lines of a first cache set when the table entry corresponding to the first cache set is evicted from the table.

8. The apparatus of claim 3, wherein the harvesting unit is capable of selecting the dirty cache lines corresponding to a first page of the external memory device by the harvesting signal as the candidates for cleaning when the number of the dirty cache lines corresponding to the first page exceeds a threshold and the external memory device performs other write operations, and the harvesting unit comprises:
a counter, capable of counting the number of dirty cache lines corresponding to one or more pages of the external memory device, the data stored in the dirty cache line is not consistent with the corresponding data stored in the external memory device.

9. The apparatus of claim 8, wherein the harvesting unit is capable of constructing a table stored in a cache array for storing a plurality of tags, wherein each tag corresponds to one or more pages of the external memory device and stores data corresponding to the addresses of the dirty cache lines of the one or more pages.

10. The apparatus of claim 9, wherein the harvesting unit is capable of selecting the dirty cache lines corresponding to a first tag of the plurality of tags by the harvesting signal as the candidates for cleaning when the number of dirty cache lines corresponding to the first tag exceeds a threshold.

11. The apparatus of claim 9, wherein the harvesting unit is capable of selecting the dirty cache lines corresponding to a first tag of the plurality of tags by the harvesting signal as the candidate for cleaning when the first tag is evicted from the cache array.

12. The apparatus of claim 9, wherein the locations of the dirty cache lines corresponding to a page of the external memory device are found by looking up the cache array.

13. A harvesting method for a cache device, comprising:
counting the number of dirty cache lines of the cache device corresponding to one or more pages of an external memory device; and
writing data stored in one or more dirty cache lines corresponding to a first page of the external memory device back to the external memory device when the number of the dirty cache lines corresponding to the first page exceeds a threshold and an external memory control module the cache device writes data to the first page of the external memory device;
wherein the data stored in the dirty cache line is not consistent with the corresponding data stored in the external memory device.

14. The harvesting method of claim 13 further comprising:
Constructing a table stored in a cache array for storing a plurality of tags, wherein each tag corresponds to one or more pages of the external memory device and stores data corresponding to the addresses of the dirty cache lines of the one or more pages.

15. The harvesting method of claim 14 further comprising:
writing data of the dirty cache lines corresponding to a first tag of the plurality of tags back to the external memory device when the number of the dirty cache lines corresponding to the first tag exceed a threshold.

16. The harvesting method of claim 15 further comprising:
writing data of the dirty cache lines corresponding to a first tag of the plurality of tags back to the external memory device when the first tag is evicted from the cache array.

17. A harvesting method for a cache device having a plurality of cache sets, comprising:
counting the number of dirty cache lines in one or more cache sets; and
writing the data stored in one or more dirty cache lines of a first cache set back to an external memory device when number of dirty cache lines stored in the first cache set exceeds a threshold and the external memory device performs write operations;
wherein the data stored in the dirty cache line is not consistent with the corresponding data stored in the external memory device.

18. The harvesting method of claim 17 further comprising:
writing the data stored in one or more dirty cache lines of a second cache set corresponding to a first page of the external memory device back to the external memory device when writing the data stored in one or more dirty cache lines of the first cache set corresponding to the first page back to the external memory device.

19. The harvesting method of claim 17, wherein the step of counting the number of dirty cache lines stored in each cache set comprises:
building a table for ranking the number of dirty cache lines in one or more cache sets.

20. The harvesting method of claim 19 further comprises:
writing the data stored in one or more dirty cache lines of a second cache set when the second cache set is evicted from the table.
